(19) United States
(12) Patent Application Publication
(10) Pub. No.: US 2024/0242076 A1
(43) Pub. Date: Jul. 18, 2024

(54) METHOD AND DEVICE FOR TESTING DEEP LEARNING MODEL AND COMPUTER STORAGE MEDIUM

(71) Applicant: BOE TECHNOLOGY GROUP CO., LTD., Beijing (CN)

(72) Inventor: Peng HU, Beijing (CN)

(21) Appl. No.: 18/563,594

(22) PCT Filed: May 26, 2021
(86) PCT No.: PCT/CN2021/096132

§ 371 Date: Nov. 22, 2023

(51) Int. Cl. G06N 3/08

(52) U.S. Cl. CPC G06N 3/08

(57) ABSTRACT

The present disclosure discloses a method, apparatus and computer storage medium for testing a deep learning model, which provides an automatic process for accelerating and testing the deep learning model. The method includes acquiring a deep learning model to be deployed; accelerating, in response to an acceleration instruction specified by a user, the deep learning model according to an acceleration method corresponding to the acceleration instruction so as to improve an inference speed of the deep learning model; acquiring test samples corresponding to the deep learning model after the acceleration is finished; and testing the deep learning model by using the test samples.

### FIELD OF THE PRESENT DISCLOSURE

The present disclosure relates to the field of the automated testing technology, and in particular, to a method and device for testing a deep learning model, and a computer storage medium.

### BACKGROUND OF THE PRESENT DISCLOSURE

At present, deep learning algorithms are widely applied in various fields. For the current challenges of effectively deploying deep learning models on different hardware platforms, the explosive growth in the size and computational cost of deep learning models has brought varying degrees of difficulties to the actual deployment process. Currently, before deploying deep learning models on edge devices, manual inference acceleration and compilation testing are required, resulting in high labor costs and low efficiency.

Therefore, how to automate acceleration and testing of different deep learning models based on different hardware resources (such as the size of an on-chip memory, the number of arithmetic units, and the like), in order to efficiently deploy deep learning models on edge devices, is an urgent technical problem that needs to be solved.

### SUMMARY OF THE PRESENT DISCLOSURE

As a first aspect, an embodiment of the present disclosure provides a method for testing a deep learning model, the method being applied to an edge device, and the method includes: acquiring a deep learning model to be deployed; acquiring an acceleration instruction specified by a user, and accelerating the deep learning model according to an acceleration method corresponding to the acceleration instruction so as to improve an inference speed of the deep learning model; acquiring test samples corresponding to the deep learning model after the acceleration is finished; and testing the deep learning model by using the test samples.

In some embodiments, before accelerating the deep learning model, the method further includes: selecting, in response to a plurality of acceleration methods corresponding to the acceleration instruction, one of the plurality of acceleration methods meeting a preset performance index according to a type of a system and hardware performance of the edge device used for current test of the deep learning model.

In some embodiments, before testing the deep learning model by using the test samples, the method further includes: determining a compiler according to a type of a system of the edge device used for current test of the deep learning model; and compiling and packaging, by the compiler, algorithmic code corresponding to the deep learning model into a library.

In some embodiments, a type of the packaged library is determined by: determining, in response to that the compiler is one of GCC compiler, G++ compiler and a cross compiler, the type of the packed library as a Shared Object (SO) library; and determining, in response to that the compiler is a Windows compiler, the type of the packed library as a Dynamic-Link Library (DLL).

In some embodiments, determining the compiler includes one of: determining that the compiler is one of a GCC compiler, a G++ compiler or a cross compiler in response to that a Linux system is used for current test; determining that the compiler is one of a GCC compiler, a G++ compiler or a cross compiler in response to that an ARM-Linux system is used for current test; determining that the compiler is one of a GCC compiler, a G++ compiler or a cross compiler in response to that an Android system is used for current test; and determining that the compiler is a Windows compiler in response to that a Windows system is used for current test.

In some embodiments, after compiling and packaging, by the compiler, algorithmic code corresponding to the deep learning model into a library, the method further includes: encapsulating at least one preset function library into the library, wherein the preset function library is configured to realize one or more of an authentication function, an encryption function and a network function.

In some embodiments, after testing the deep learning model by using the test samples, the method further includes: generating a test report according to test data obtained in the testing.

In some embodiments, the acceleration method includes one or more of: a mobile neural network (MNN); an inference framework TNN; and a neural network inference engine Tengine-Lite.

As a second aspect, an embodiment of the present disclosure provides an apparatus for testing a deep learning model, wherein the apparatus includes a processor and a memory storing a program executable by the processor, and the processor is configured to read the program from the memory and perform the following steps: acquiring a deep learning model to be deployed; acquiring an acceleration instruction specified by a user, and accelerating the deep learning model according to an acceleration method corresponding to the acceleration instruction so as to improve an inference speed of the deep learning model; acquiring test samples corresponding to the deep learning model after the acceleration is finished; and testing the deep learning model by using the test samples.

In some embodiments, before accelerating the deep learning model, processor is configured to perform: selecting, in response to a plurality of acceleration methods corresponding to the acceleration instruction, one of the plurality of acceleration methods meeting a preset performance index according to a type of a system and hardware performance of the edge device used for current test of the deep learning model.

In some embodiments, before testing the deep learning model by using the test samples, the processor is configured to perform: determining a compiler according to a type of a system of the edge device used for current test of the deep learning model; and compiling and packaging, by the compiler, algorithmic code corresponding to the deep learning model into a library.

In some embodiments, the processor is configured to determine a type of the packaged library by: determining, in response to that the compiler is one of GCC compiler, G++ compiler and a cross compiler, the type of the packed library as a Shared Object (SO) library; and determining, in response to that the compiler is a Windows compiler, the type of the packed library as a Dynamic-Link Library (DLL).

In some embodiments, the processor is configured to determine the compiler by: determining that the compiler is one of a GCC compiler, a G++ compiler or a cross compiler in response to that a Linux system is used for current test; determining that the compiler is one of a GCC compiler, a G++ compiler or a cross compiler in response to that an ARM-Linux system is used for current test; determining that the compiler is one of a GCC compiler, a G++ compiler or a cross compiler in response to that an Android system is used for current test; and determining that the compiler is a Windows compiler in response to that a Windows system is used for current test.

In some embodiments, after compiling and packaging, by the compiler, algorithmic code corresponding to the deep learning model into a library, the processor is configured to perform: encapsulating at least one preset function library into the library, wherein the preset function library is configured to realize one or more of an authentication function, an encryption function and a network function.

In some embodiments, after testing the deep learning model by using the test samples, the processor is configured to perform: generating a test report according to test data obtained in the testing.

In some embodiments, the acceleration method includes one or more of: a mobile neural network (MNN); an inference framework TNN; and a neural network inference engine Tengine-Lite.

As a third aspect, an embodiment of the present disclosure provides a device for testing a deep learning model, which includes: a model acquiring unit, a model acceleration unit, a sample acquiring unit, and a model testing unit. The model acquiring unit is configured to obtain a deep learning model to be deployed. The model acceleration unit is configured to obtain an acceleration instruction specified by a user, and accelerate the deep learning model according to an acceleration method corresponding to the acceleration instruction, so as to improve an inference speed of the deep learning model. The sample acquiring unit is configured to obtain test samples corresponding to the deep learning model after the acceleration is completed. The model testing unit is configured to test the deep learning model by using the test samples.

In some embodiments, before accelerating the deep learning model, the model acceleration unit is further configured to:

If a plurality of acceleration methods correspond to the acceleration instruction, selecting one of the acceleration methods meeting a preset performance index according to a type of a system of the edge device and the hardware performance of the edge device used for current test of the deep learning model.

In some embodiments, the device further includes a compiling unit specifically configured to: before testing the deep learning model by using the test samples:
Determining a compiler according to the type of the system of the edge device used for current test of the deep learning model; and
Compiling the algorithmic code corresponding to the deep learning model by using the compiler, and packaging it into a library.

In some embodiments, the compiling unit is configured to determine the type of the packaged library by the following steps:
If the compiler is one of GCC, G++ and cross compilers, determining the type of the packed library as a SO library; and
If the compiler is a Windows compiler, determining the type of the packed library as a DLL library.

In some embodiments, the compiling unit is configured to determine the compiler by one or more of following steps:
If a Linux system is used for the current test, determining that the compiler is one of GCC, G++ and cross compilers;
If an ARM-Linux system is used in the current test, determining that the compiler is one of GCC, G++ and cross compilers;
If an Android system is used in the current test, determining that the compiler is one of GCC, G++ and cross compilers; and
If a Windows system is used in the current test, determining that the compiler is a Windows compiler.

In some embodiments, after compiling, by the compiler, the algorithmic code corresponding to the deep learning model and packaging it into a library, the compiling unit is further configured to: encapsulating at least one preset function library into the library, wherein the preset function library may realize one or more of an authentication function, an encryption function, and a network function.

In some embodiments, after testing the deep learning model by using the test samples, the model testing unit is further configured to: generating a test report according to the test data obtained in the test.

In some embodiments, the acceleration method includes one or more of: a mobile neural network MNN; an inference framework TNN; and a neural network inference engine Tengine-Lite.

As a fourth aspect, an embodiment of the present disclosure provides a computer storage medium storing a computer program which, when executed by a processor, cause the processor to perform the method according to the first aspect.

Those or other aspects of the present disclosure will be more concise and understandable in the description of the following embodiments.

### BRIEF DESCRIPTION OF THE DRAWINGS

In order to provide a clearer explanation of the technical solution in the embodiments in the present disclosure, a brief description of the drawings required in the embodiments will be illustrated. It is obvious that the accompanying drawings in the following description are only some embodiments of the present disclosure. For those skilled in the art, other accompanying drawings may be obtained based on these drawings without any creative effort.

FIG. 1 is a flowchart showing a method for testing a deep learning model according to an embodiment of the present disclosure;

FIG. 2 is a flow chart showing an automated test method according to an embodiment of the present disclosure;

FIG. 3A is a schematic diagram of a configuration of enabling authentication function according to an embodiment of the present disclosure;

FIG. 3B is a schematic diagram of a configuration of enabling authentication function according to an embodiment of the present disclosure;

FIG. 3C is a schematic diagram of a configuration of enabling authentication function according to an embodiment of the present disclosure;

FIG. 4 is a flowchart showing an automated test method according to an embodiment of the present disclosure;

FIG. 5 is a flowchart showing a complete automated test method according to an embodiment of the present disclosure;

FIG. 6 is a schematic diagram showing an apparatus for testing a deep learning model according to an embodiment of the present disclosure; and

FIG. 7 is a schematic diagram of a device for testing a deep learning model according to an embodiment of the present disclosure.

### DETAILED DESCRIPTION OF THE EXEMPLARY EMBODIMENTS

In order to make the purpose, technical solution, and advantages of the present disclosure clearer, further detailed descriptions will be given below in conjunction with the accompanying drawings. Obviously, the described embodiments are only a part of the embodiments of the present disclosure, not all of them. Based on the embodiments in the present disclosure, all other embodiments obtained by those skilled in the art without inventiveness work fall within the protection scope of the present disclosure.

The application scenarios described in the embodiments in the present disclosure are intended to provide a clearer explanation of the technical solution of the embodiments in the present disclosure, and do not constitute a limitation on the technical solution in the embodiments in the present disclosure. As ordinary technical personnel in the art know, with the emergence of new application scenarios, the technical solution in the embodiments in the present disclosure is also applicable to similar technical problems. In the description of the present disclosure, unless otherwise specified, “a plurality of” means two or more.

With the widespread application of deep learning models, manual acceleration and testing of a deep learning model are required before deploying the deep learning model on edge devices, which consumes a lot of manpower and high costs. The embodiments of the present disclosure provide an automated process for testing a deep learning model, which can be applied online or offline to improve testing efficiency and save labor costs. It should be noted that due to the computational complexity of the deep learning model, the deep learning model cannot be directly deployed on the edge device. Therefore, it is necessary to accelerate the deep learning model, reduce parameter redundancy, reduce storage occupation, and reduce computational complexity.

In some embodiments, the method for testing a deep learning model in the embodiment may be applied to an offline device such as an edge device which includes but not limited to, a computing workstation, a PC terminal, a chip board, and the like. An operating system of the edge device includes but not limited to, Windows, Linux, Android, and the like.

The core idea of the method for testing a deep learning model according to the embodiment of the present disclosure is to establish an automatic flow at edge device, wherein the automatic flow includes: acquiring a deep learning model; accelerating the deep learning model; and acquiring test samples after the acceleration is finished, so as to realize a one-key acceleration test method, thereby improving the deployment efficiency of the deep learning model. When the deep learning model is tested, since the algorithm of the deep learning model is complex, an apparatus including a processor with larger data processing capacity is required for testing the deep learning model, generally a cloud server may be used for testing the deep learning model. In addition, at present, when performing the testing of the deep learning model, only the deep learning algorithm itself is tested. Even after the testing process is completed, if the tested deep learning model is directly deployed on the edge device, the data processing capacity of the edge device cannot support the complex algorithm operation process of the deep learning model since the deep learning model has a complex operation process, so that the deep learning model cannot run on the edge device. Therefore, the existing test on the deep learning model can only be performed based on the cloud server, and the deep learning model after testing cannot be deployed on the edge device. The present disclosure provides a method for realizing the automatic testing of the deep learning model through the edge device by automatically accelerating the obtained deep learning model, which reduces the calculated amount of the deep learning model, thereby realizing the automatic testing process of the deep learning model on the edge device, and accelerates the deployment of the deep learning model on the edge device, thereby effectively shortening the deployment period. The testing process in the embodiment is a standardized and automatic deep learning model testing process suitable for various deep learning models, can meet the testing requirements of various deep learning models, and can improve the efficiency of deploying the deep learning models at the edge device when the edge device is used for testing.

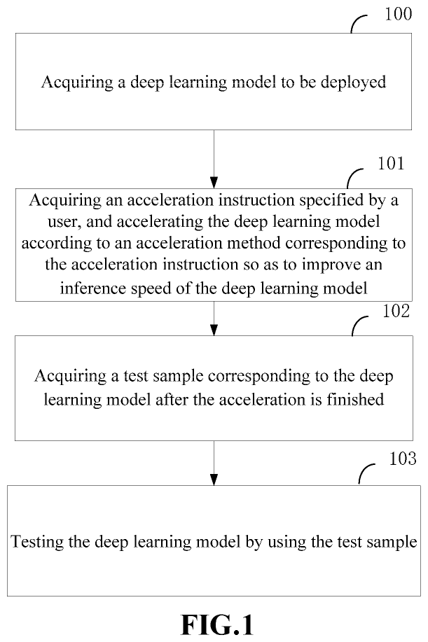

As shown in FIG. 1, the process of the test method in the embodiment includes Steps 100 to 103.

At Step 100, acquiring a deep learning model to be deployed.

The embodiment may automatically accelerate and test various deep learning models. In some embodiments, the deep learning model to be deployed may be stored in a model warehouse. The model warehouse is configured to store various deep learning models. In implementation, different deep learning models may be stored in corresponding path addresses, with a storage form including but not limited to code, mirror code, etc. of deep learning models.

In some embodiments, the deep learning model to be deployed may be obtained from a local server or a cloud server.

At Step 101, acquiring an acceleration instruction specified by a user, and accelerating the deep learning model according to an acceleration method corresponding to the acceleration instruction so as to improve an inference speed of the deep learning model.

The corresponding relationship between the acceleration instruction and the acceleration method obtained in the embodiment includes but is not limited to, part or all of the following relationships: one-to-one correspondence, one-to-many correspondence, or many-to-many correspondence.

One-to-one correspondence means that when one acceleration instruction is obtained, the acceleration instruction corresponds to one acceleration method, and the deep learning model is accelerated according to the acceleration method corresponding to the acceleration instruction in the implementation. One-to-many correspondence means that when one acceleration instruction is obtained, the acceleration instruction corresponds to multiple acceleration methods, and the deep learning model is accelerated simultaneously or separately in stages according to the multiple acceleration methods corresponding to the acceleration instruction in the implementation. Many-to-many correspondence means that when a plurality of acceleration instructions are obtained, each of the acceleration instructions corresponds to one acceleration method, and the deep learning model is accelerated simultaneously or separately in stages according to the acceleration methods corresponding to the acceleration instructions in the implementation.

In some embodiments, if the acceleration instruction specified by the user corresponds to one acceleration method, the deep learning model is accelerated according to the acceleration method specified by the user.

In some embodiments, if a plurality of acceleration methods correspond to the acceleration instruction specified by the user, according to the system type of the edge device and the hardware performance of the edge device used for current test of the deep learning model, one acceleration method meeting a preset performance index is selected from the plurality of acceleration methods. In some examples, the preset performance index includes, but is not limited to, optimal performance and/or fastest running speed. In the implementation, system types include but are not limited to: Windows, Linux, and Android. The hardware performance may be determined according to performance of a processor (CPU), a size of a memory, etc. of the edge device. In implementation, selecting the acceleration method meeting the preset performance index includes one or more of the followings Methods 1 to 4.
Method 1, during the process of accelerating the deep learning model by the edge device, selecting an acceleration method with the maximum number of lines of codes for running the deep learning model in unit time, namely, selecting an acceleration method with the fastest operation speed.
Method 2, during the process of accelerating the deep learning model by the edge device, selecting an acceleration method with the least occupancy rate of the CPU of the edge device, namely, selecting an acceleration method with the optimal performance.
Method 3, during the process of accelerating the deep learning model by the edge device, selecting an acceleration method with the maximum number of lines of codes for running the deep learning model in unit time and the least occupancy rate of the CPU of the edge device, namely, selecting an acceleration method with the fastest running speed and the least occupancy rate of the CPU.
Method 4, during the process of accelerating the deep learning model by the edge device, selecting an accelerating method with a minimum sum value by weighting and summing the occupancy rate of the CPU and the running speed obtained in the accelerating process according to the weights respectively corresponding to the performance and the running speed.

In some embodiments, the acceleration method according to the embodiment includes, but is not limited to, one or more of the following:

A Mobile Neural Network (MNN); an inference framework TNN (i.e., Tensor Networks with Inference); and a neural network inference engine Tengine-Lite.

At Step 102, acquiring test samples corresponding to the deep learning model after the acceleration is finished.

In an implementation, the test samples may be stored in a data warehouse that stores the test samples corresponding to the deep learning model.

At Step 103, testing the deep learning model by using the test samples.

In order to facilitate the deployment of the deep learning model on the edge device, the automated testing process in the embodiment realizes a complete automation process of obtaining, accelerating, and testing the deep learning model, thereby improving the efficiency of preparation work for deployment, and saving manpower and costs. In addition, due to the accelerating process of the deep learning model, the automated testing process can effectively reduce the computational complexity of the deep learning model to improve processing speed, especially for the edge device on the local terminal, the testing process in the embodiment can still be utilized to ensure offline testing.

In some embodiments, the plurality of acceleration methods involved in the embodiment include, but are not limited to, MNN, TNN, and Tengine-Lite. Among the three acceleration methods, the user may specify or select one acceleration method with the minimum running speed and the minimum occupancy rate of the CPU. The three acceleration methods in the embodiment will be illustrated as follows.

### Method 1: MNN.

MNN is a lightweight deep neural network inference engine that focuses on solving the end-to-end inference operation problem of the deep neural network model, covering the optimization, transformation, and inference of the deep neural network model. MNN may include two parts: converter and interpreter.

Converter includes a Frontend and graphic optimizer. The Frontend may support different training frameworks. MNN currently supports Tensflow (Lite), Caffe, and ONNX. The graph optimizer may optimize the graphs through operator fusion, operator substitution, layout adjustment, and the like.

The Interpreter includes an Engine and a Backend. The Engine may load the model and schedule the Computational Graph. The backend may be used to allocate memory for each computing device. In Engine and Backend, MNN employs various optimization schemes, including Winograd algorithm in convolution and deconvolution, Strassen algorithm in matrix multiplication, low precision computing, handwriting assembly, multithreading optimization, memory reuse, heterogeneous computing, etc.

### Method 2: TNN;

TNN is a high-performance and lightweight reasoning framework of a mobile terminal, and has outstanding advantages such as cross-platform performance, high performance, model compression, code clipping and the like. TNN includes model conversion, low-precision optimization, operator compiling optimization, a computing engine, a hardware architecture and the like. The model conversion may be used for model analysis and conversion. The low-precision optimization may be used for FP16 low-precision conversion and INT8 post-training quantization. The operator compiling optimization includes operator tuning, layout optimization, computational graph optimization and the like. The computing engine includes a high-performance kernel implementation and a high-performance memory scheduling. The hardware architecture includes ARM, GPU, NPU and the like.

### Method 3: Tengine-Lite.

Tengine-Lite realizes rapid and efficient deployment of a deep learning neural network model on embedded apparatus. The characteristics of Tengine Lite are that: it only relies on the C library, has an independent model loading process, maintains a unified application interface with Tengine (i.e., Web server project), supports CMSIS-NN and HCL-M operator libraries, supports AI accelerators and heterogeneous computing, opens support for Cafe/TensorFlow/MXNet models, and provides model quantification training tools. TNN has advantages such as lightweight, easy to deploy, decoupled model deployment and model run code, Cortex-A/M unified ecosystem, easy porting of MCU applications to AP, support for operator customization development, while improving performance, adapting to embedded AI platforms, and giving developers more freedom of choice.

In some embodiments, before the deep learning model is tested by using the test samples, the embodiment further provides a compiling method, which specifically includes Step 1 and Step 2.

At Step 1, determining a compiler according to a type of a system of the edge device used for current test of the deep learning model.

In some embodiments, different systems correspond to one or more method for determining the compiler.
11) If a Linux system is used for current test, determining that the compiler is one of a GCC compiler, a G++ compiler, or a cross compiler.
12) If an ARM-Linux system is used for current test, determining that the compiler is one of a GNU Compiler Collection (GCC), a G++(GUN C++) compiler, or a cross compiler.
13) If an Android system is used in current test, determining that the compiler is one of a GCC compiler, a G++ compiler, or a cross compiler.
14) If a Windows system is used in the current test, determining that the compiler is a Windows compiler.

At Step 2, compiling, by the compiler, algorithmic code corresponding to the deep learning model, and packaging it into a library.

In some embodiments, for Linux, ARM-Linux, and Android systems, compiling and packaging the algorithm code into SO library format by using one of the GCC, G++, and cross-compilers through the cross-platform installation (i.e., compilation) tool CMAKE. For the Windows systems, the execution of the compiler is controlled by setting macro switches, specifying whether the Windows compiler needs to be executed, and compiling the algorithm code into a DLL library format. That is, the embodiment provides one or more types of libraries, and the type of the packaged library may be determined as follows.

If the compiler is one of GCC, G++ and cross compilers, determining the type of the packed library as a SO library (i.e., Shared Object library).

If the compiler is a Windows compiler, determining the type of the packed library as a DLL library (i.e., Dynamic-Link Library).

The embodiment provides an automated process for accelerating, compiling, and testing the deep learning model, achieving one click compilation and one click packaging, accelerating the deployment of the deep learning model

In some embodiments, one or more of the following middlewares are included in the automated process in the embodiment, and the middlewares are not limited to the followings.
1. A model warehouse for storing a deep learning model to be deployed.
2. A code warehouse for storing algorithmic code corresponding to the deep learning model to be deployed.
3. A data warehouse for storing test samples, test data, test reports and the like corresponding to the deep learning model to be deployed.
4. A Docker mirror image of a compiling platform for compiling and packaging the deep learning model.

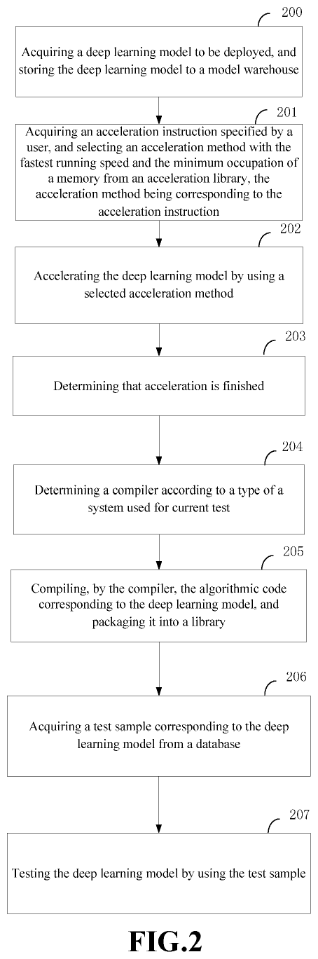

In some embodiments, as shown in FIG. 2, an automated test process in an embodiment of the present disclosure includes Step S200 to Step 207.

At Step 200, acquiring a deep learning model to be deployed, and storing the deep learning model to a model warehouse.

At Step 201, acquiring an acceleration instruction specified by a user, and selecting an acceleration method with the minimum running speed and the minimum occupation of a memory from an acceleration library, the acceleration method being corresponding to the acceleration instruction.

At Step 202, accelerating the deep learning model by using a selected acceleration method.

At Step 203, determining that acceleration is finished.

At Step 204, determining a compiler according to a type of a system used for current test.

At Step 205, compiling, by the compiler, the algorithmic code corresponding to the deep learning model, and packaging it into a library.

At Step 206, acquiring test samples corresponding to the deep learning model from a database.

At Step 207, testing the deep learning model by using the test samples.

In some embodiments, in order to provide some functions for a user after the deep learning model is deployed on the edge device, some function libraries may be further encapsulated into the algorithmic code of the deep learning model by using a compiling macro after the algorithmic code is compiled, so that the functions of the function libraries may be used after the deep learning model is deployed on the edge device. The specific implementation is as follows.

Encapsulating at least one preset function library into the deep learning model, wherein the preset function library may realize one or more of an authentication function, an encryption function and a network function. The functions realized by the function libraries will be illustrated as follows.

### 1. Authentication Function:

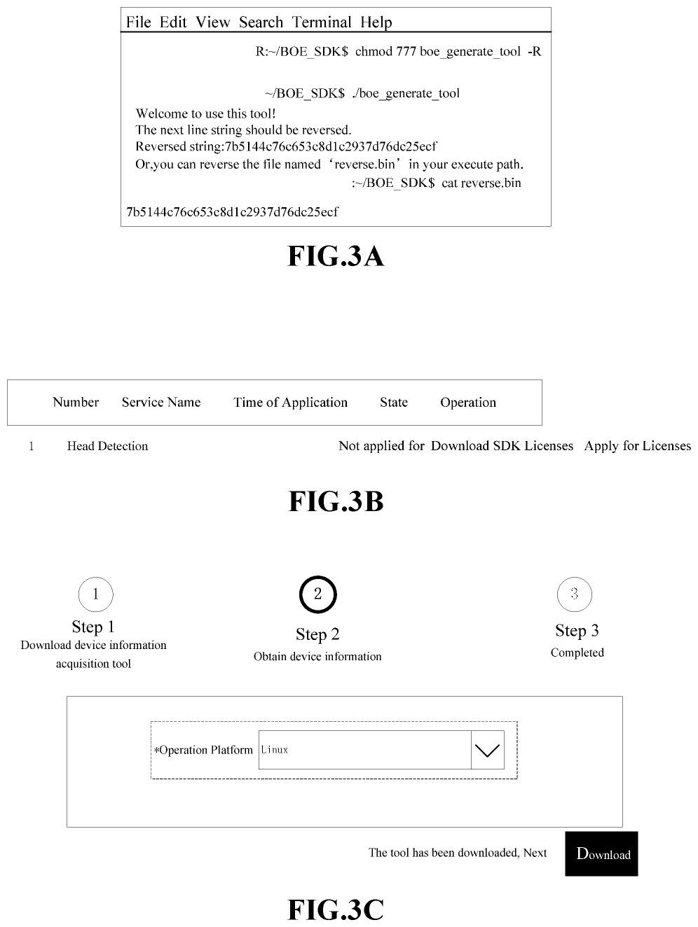

In implementation, the authentication function adopts an authorization activation mode based on a hardware fingerprint (read by a fingerprint tool) of a device (e.g., the edge device or cloud device), the device having uniqueness. If license is applied for trial every time, the validity period for license is 3 months from the application date. Permanent validity may be applied after formal purchase. Taking Linux platform as an example, the configurations shown in FIG. 3A, FIG. 3B, and FIG. 3C are required for the authentication function. After the configuration shown in FIG. 3A, in response to the click of the function button for applying for a license, the interface shown in FIG. 3C is displayed; and in response to a selection of an operation platform and a click of a download button in the interface, a license may be downloaded.

### 2. Encryption Function:

In implementation, the encryption function adopts an Advanced Encryption Standard (AES) Encryption mode to protect the algorithm model and the security of the network data transmission.

### 3. Network Function:

In implementation, the network function adopts Http Post request mode to encrypt and transmit data in a Json message mode, therefore the network function and the encryption function need to be enabled simultaneously.

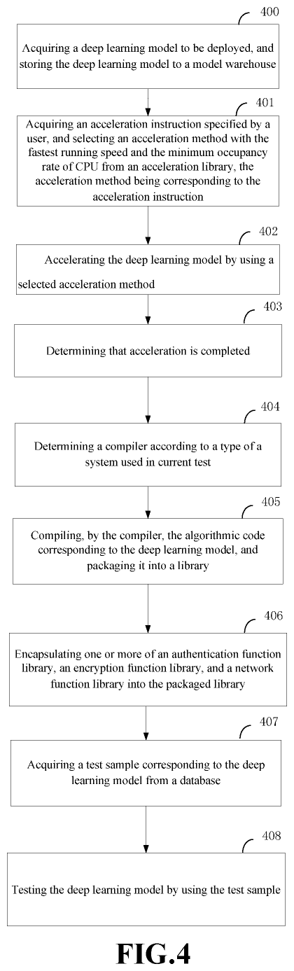

In some embodiments, an embodiment of the present disclosure further provides an automated process for testing including encapsulating a function library specified by a user into the library obtained by compiling and packaging the algorithmic code corresponding to the deep learning model, so as to implement the authentication function, the encryption function, the network function, and the like of the deep learning model. As shown in FIG. 4, the specific implementation of the process is as follows.

At Step 400, acquiring a deep learning model to be deployed, and storing the deep learning model to a model warehouse.

At Step 401, acquiring an acceleration instruction specified by a user, and selecting an acceleration method with the minimum running speed and the minimum occupancy rate of CPU from an acceleration library, the acceleration method being corresponding to the acceleration instruction.

At Step 402, accelerating the deep learning model by using a selected acceleration method.

At Step 403, determining that acceleration is completed.

At Step 404, determining a compiler according to a type of a system used in current test.

At Step 405, compiling and packaging, by the compiler, the algorithmic code corresponding to the deep learning model into a library.

At Step 406, encapsulating one or more of an authentication function library, an encryption function library, and a network function library into the packaged library.

At Step 407, acquiring test samples corresponding to the deep learning model from a database.

At Step 408, testing the deep learning model by using the test samples.

In some embodiments, one or more of the following devices may be used for testing the deep learning model in the embodiment: a server device; a cloud device; and an edge device.

In some embodiments, one or more of the following devices may be used for accelerating the deep learning model in the embodiment: a server device; a cloud device; and an edge device.

In some embodiments, one or more of the following devices may be used for compiling the deep learning model in the embodiment: a server device; a cloud device; and an edge device.

In some embodiments, after the testing the deep learning model by using the test samples, the method further includes: generating a test report according to the test data obtained in the test, so that it is convenient for a technician to check, for example, judging whether or not the deep learning model may be deployed on the edge device according to the content in the test report.

In some embodiments, the model warehouse, the code warehouse, and the data warehouse may be associated based on Gillab runner function, so as to realize the automated process for acceleration, compilation, and test of the deep learning model in the embodiment, so that the whole process is standardized, automated, and modularized, and the development cycle of the algorithm can be greatly shortened.

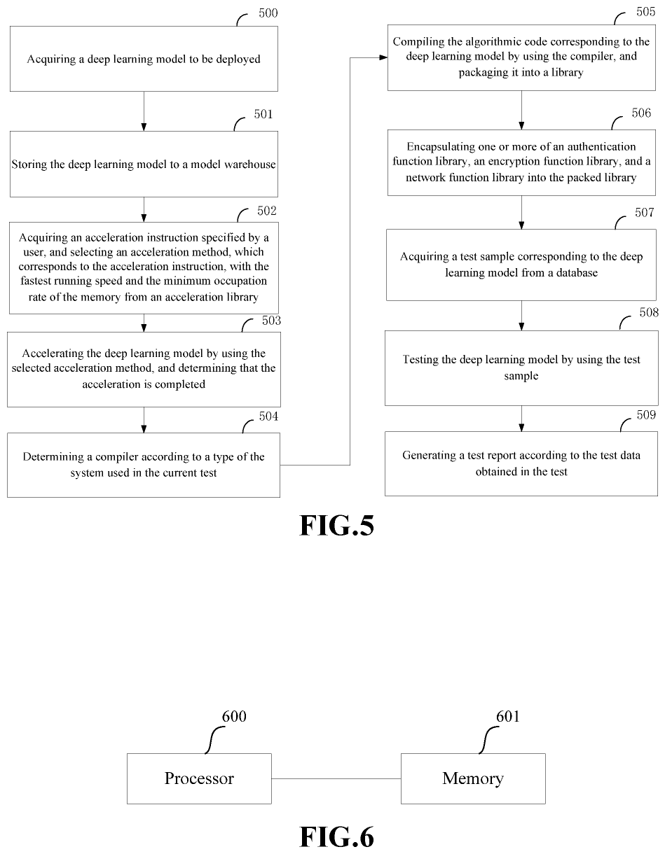

In some embodiments, as shown in FIG. 5, an embodiment further provides a complete automated testing process applied to the edge device, and the specific implementation of the process are as follows.

At Step 500, acquiring a deep learning model to be deployed.

The deep learning model to be deployed may be obtained by a cloud server or a local server, which is not limited to in the embodiment.

At Step 501, storing the deep learning model to a model warehouse.

The model warehouse is a model storage partition in the edge device for storing deep learning models.

At Step 502, acquiring an acceleration instruction specified by a user, and selecting an acceleration method, which corresponds to the acceleration instruction, with the minimum running speed and the minimum occupation rate of the memory from an acceleration library.

In implementation, by using the command line (code), the acceleration image Docker corresponding to the automatic pull-down acceleration method can be implemented; and the code corresponding to the acceleration method in the acceleration image may be used to accelerate the deep learning model.

A plurality of acceleration methods are stored in the acceleration library, and the acceleration library is an acceleration storage partition in the edge device.

At Step 503, accelerating the deep learning model by using the selected acceleration method, and determining that the acceleration is completed.

At Step 504, determining a compiler according to a type of the system used in the current test.

In implementation, the compiler may be determined according to business requirements or the type of the system.

At Step 505, compiling the algorithmic code corresponding to the deep learning model by using the compiler, and packaging it into a library.

At Step 506, encapsulating one or more of an authentication function library, an encryption function library, and a network function library into the packed library.

At Step 507, acquiring test samples corresponding to the deep learning model from a database.

In implementation, automatically pulling down the test samples in the database.

At Step 508, testing the deep learning model by using the test samples.

At Step 509, generating a test report according to the test data obtained in the test.

In some embodiments, based on the same inventive concept, an embodiment of the present disclosure further provides an apparatus for testing a deep learning model. Since the apparatus is an apparatus for realizing the method in the embodiments of the present disclosure, the principle of the apparatus for solving the problem is similar to that of the method. Therefore, the implementation of the apparatus may refer to the implementation of the method, and repeated details will not be described herein again.

As shown in FIG. 6, the apparatus includes a processor 600 and a memory 601, wherein the memory stores programs executable by the processor, and the processor reads the programs in the memory and performs the following steps.
Acquiring a deep learning model to be deployed;
Acquiring an acceleration instruction specified by a user, and accelerating the deep learning model according to an acceleration method corresponding to the acceleration instruction so as to improve an inference speed of the deep learning model;
Acquiring test samples corresponding to the deep learning model after the acceleration is finished; and
Testing the deep learning model by using the test samples.

In some embodiments, before accelerating the deep learning model, the processor is further configured to:
selecting, in response to that a plurality of acceleration methods correspond to the acceleration instruction, one of the acceleration methods meeting a preset performance index according to a type of the system of the edge device and the hardware performance of the edge device used for current test of the deep learning model.

In some embodiments, before testing the deep learning model by using the test samples, the processor is further configured to:
Determining a compiler according to the type of the system of the edge device used for current test of the deep learning model; and
Compiling the algorithmic code corresponding to the deep learning model by using the compiler, and packaging it into a library.

In some embodiments, in order to determine the type of the packaged library, the processor is configured to:
If the compiler is one of GCC, G++ and cross compilers, determining the type of the packed library as a SO library; and
If the compiler is a Windows compiler, determining the type of the packed library as a DLL library.

In some embodiments, the processor is configured to determine the compiler by one or more of following steps:
If a Linux system is used in the current test, determining that the compiler is one of GCC, G++ and cross compilers;
If an ARM-Linux system is used in the current test, determining that the compiler is one of GCC, G++ and cross compilers;
If an Android system is used in the current test, determining that the compiler is one of GCC, G++ and cross compilers; and
If a Windows system is used in the current test, determining that the compiler is a Windows compiler.

In some embodiments, after the compiling, by the compiler, the algorithmic code corresponding to the deep learning model and packaging it into a library, the processor is further configured to:
Encapsulating at least one preset function library into the library, the preset function library may implement one or more of authentication, encryption, and network functions.

In some embodiments, after testing the deep learning model by using the test samples, the processor is further configured to:
generating a test report according to the test data obtained in the test.

In some embodiments, the acceleration method includes one or more of:
A mobile neural network MNN;
An inference framework TNN; and
A neural network inference engine Tengine-Lite.

In some embodiments, based on the same inventive concept, an embodiment of the present disclosure further provides a device for testing a deep learning model. Since the device is a device for realizing the method in the embodiments of the present disclosure, the principle of the device for solving the problem is similar to that of the method, the implementation of the device may refer to the implementation of the method, and repeated details will not be described herein.

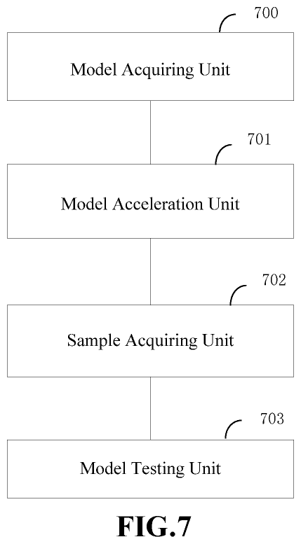

As shown in FIG. 7, the device includes a model acquiring unit 700, a model acceleration unit 701, a sample acquiring unit 702, and a model testing unit 703.

The model acquiring unit 700 is configured to obtain a deep learning model to be deployed.

The model acceleration unit 701 is configured to obtain an acceleration instruction specified by a user, and accelerate the deep learning model according to an acceleration method corresponding to the acceleration instruction, so as to improve an inference speed of the deep learning model.

The sample acquiring unit 702 is configured to obtain test samples corresponding to the deep learning model after the acceleration is completed.

The model testing unit 703 is configured to test the deep learning model by using the test samples.

In some embodiments, before accelerating the deep learning model, the model acceleration unit is further configured to:

If a plurality of acceleration methods correspond to the acceleration instruction, selecting one of the acceleration methods meeting a preset performance index according to a type of a system of the edge device and the hardware performance of the edge device used for current test of the deep learning model.

In some embodiments, the device further includes a compiling unit specifically configured to: before testing the deep learning model by using the test samples:
Determining a compiler according to the type of the system of the edge device used for current test of the deep learning model; and
Compiling the algorithmic code corresponding to the deep learning model by using the compiler, and packaging it into a library.

In some embodiments, the compiling unit is configured to determine the type of the packaged library by the following steps:
If the compiler is one of GCC, G++ and cross compilers, determining the type of the packed library as a SO library; and
If the compiler is a Windows compiler, determining the type of the packed library as a DLL library.

In some embodiments, the compiling unit is configured to determine the compiler by one or more of following steps:
If a Linux system is used for the current test, determining that the compiler is one of GCC, G++ and cross compilers;
If an ARM-Linux system is used in the current test, determining that the compiler is one of GCC, G++ and cross compilers;
If an Android system is used in the current test, determining that the compiler is one of GCC, G++ and cross compilers; and
If a Windows system is used in the current test, determining that the compiler is a Windows compiler.

In some embodiments, after compiling, by the compiler, the algorithmic code corresponding to the deep learning model and packaging it into a library, the compiling unit is further configured to:
Encapsulating at least one preset function library into the library, wherein the preset function library may realize one or more of an authentication function, an encryption function, and a network function.

In some embodiments, after testing the deep learning model by using the test samples, the model testing unit is further configured to:
Generating a test report according to the test data obtained in the test.

In some embodiments, the acceleration method includes one or more of:
A mobile neural network MNN;
An inference framework TNN; and
A neural network inference engine Tengine-Lite.

In some embodiments, based on the same inventive concept, an embodiment in the present disclosure also provides a computer storage medium storing computer programs thereon, which when executed by a processor, performs the following steps:
Acquiring a deep learning model to be deployed;
Acquiring an acceleration instruction specified by a user, and accelerating the deep learning model according to an acceleration method corresponding to the acceleration instruction so as to improve an inference speed of the deep learning model;
Acquiring test samples corresponding to the deep learning model after the acceleration is finished; and
Testing the deep learning model by using the test samples.

Those skilled in the art should understand that embodiments in the present disclosure may be provided as methods, systems, or computer program products. Therefore, the embodiments of the present disclosure may be in the form of complete hardware, complete software, or combining software and hardware. Moreover, the present disclosure may be in the form of computer program products implemented on one or more computer available storage media (including but not limited to, disk storage, CD-ROM, optical storage, etc.) containing computer available program codes.

The present disclosure is described with reference to the flowchart and/or block diagram of the method, device (system), and computer program product according to the embodiments of the present disclosure. It should be understood that each process and/or block in a flowchart and/or block diagram as well as the combination of processes and/or blocks in the flowchart and/or block diagram may be implemented by computer program instructions. These computer program instructions may be provided to processors of general-purpose computers, specialized computers, embedded processors, or other programmable data processing devices to provide a device that generates instructions executed by a processor of a computer or other programmable data processing device to implement the functions specified in one or more processes and/or blocks of the flowchart.

These computer program instructions may alternatively be stored in computer readable memory, which operates in a specific way, of a computer or other programmable data processing device, so that the instructions stored in the computer readable memory provides a product including the instructions implementing the functions specified in one or more processes and/or blocks of the flowchart.

These computer program instructions may alternatively be loaded onto a computer or other programmable data processing device so that the computer or other programmable device executes a series of operational steps to provide computer-implemented processing, and thus instructions executed on the computer or other programmable device may realize the steps for implementing the functions specified in one or more processes and/or one or more blocks of the flowchart.

Although preferred embodiments of the present disclosure have been described, those skilled in the art may make additional changes and modifications to these embodiments once they become aware of the basic creative concepts. Therefore, the attached claims are intended to be interpreted as including preferred embodiments and all changes and modifications falling within the scope of the present disclosure.

Obviously, those skilled in the art may make various modifications and variations to the embodiments of the present disclosure without departing from the spirit and scope of the embodiments of the present disclosure. In this way, if these modifications and variations of the embodiments of the present disclosure fall within the scope of the claims of the present disclosure and their equivalent technologies, the present disclosure also intends to include these modifications and variations.

1. A method for testing a deep learning model, the method being applied to an edge device, and the method comprising:
acquiring a deep learning model to be deployed;
acquiring an acceleration instruction specified by a user, and accelerating the deep learning model according to an acceleration method corresponding to the acceleration instruction so as to improve an inference speed of the deep learning model;
acquiring test samples corresponding to the deep learning model; and
testing the deep learning model by using the test samples.

2. The method of claim 1, before accelerating the deep learning model, the method further comprising:
selecting, in response to a plurality of acceleration methods corresponding to the acceleration instruction, one of the plurality of acceleration methods meeting a preset performance index according to a system type and hardware performance of the edge device used for current test of the deep learning model.

3. The method of claim 1, before testing the deep learning model by using the test samples, the method further comprising:
determining a compiler according to a system type of the edge device used for current test of the deep learning model; and
compiling and packaging, by the compiler, algorithmic code corresponding to the deep learning model into a library.

4. The method of claim 3, wherein a type of the packaged library is determined by:
determining, in response to that the compiler is one of GCC compiler, G++ compiler and a cross compiler, the type of the packed library as a Shared Object (SO) library; and
determining, in response to that the compiler is a Windows compiler, the type of the packed library as a Dynamic-Link Library (DLL).

5. The method of claim 3, wherein determining the compiler comprises one of:
determining that the compiler is one of a GCC compiler, a G++ compiler or a cross compiler in response to that a Linux system is used for current test;
determining that the compiler is one of a GCC compiler, a G++ compiler or a cross compiler in response to that an ARM-Linux system is used for current test;
determining that the compiler is one of a GCC compiler, a G++ compiler or a cross compiler in response to that an Android system is used for current test; and
determining that the compiler is a Windows compiler in response to that a Windows system is used for current test.

6. The method of claim 3, wherein after compiling and packaging, by the compiler, algorithmic code corresponding to the deep learning model into a library, the method further comprises:
encapsulating at least one preset function library into the library, wherein the preset function library is configured to realize one or more of an authentication function, an encryption function and a network function.

7. The method of claim 1, wherein after testing the deep learning model by using the test samples, the method further comprises:
generating a test report according to test data obtained in the testing.

8. The method of claim 1, wherein the acceleration method comprises one or more of:
a mobile neural network (MNN);
an inference framework TNN; and
a neural network inference engine Tengine-Lite.

9. An apparatus for testing a deep learning model, wherein the apparatus comprises a processor and a memory storing a program executable by the processor, and the processor is configured to read the program from the memory and perform steps of:
acquiring a deep learning model to be deployed;
acquiring an acceleration instruction specified by a user, and accelerating the deep learning model according to an acceleration method corresponding to the acceleration instruction so as to improve an inference speed of the deep learning model;
acquiring test samples corresponding to the deep learning model; and
testing the deep learning model by using the test samples.

10. A computer storage medium storing a computer program which, when executed by a processor, causes the processor to perform the method comprising:
acquiring a deep learning model to be deployed;
acquiring an acceleration instruction specified by a user, and accelerating the deep learning model according to an acceleration method corresponding to the acceleration instruction so as to improve an inference speed of the deep learning model;
acquiring test samples corresponding to the deep learning model; and
testing the deep learning model by using the test samples.

11. The apparatus of claim 9, before accelerating the deep learning model, the processor is configured to perform a step of:
selecting, in response to a plurality of acceleration methods corresponding to the acceleration instruction, one of the plurality of acceleration methods meeting a preset performance index according to a system type and hardware performance of the edge device used for current test of the deep learning model.

12. The apparatus of claim 9, before testing the deep learning model by using the test samples, the processor is configured to perform a step of:
determining a compiler according to a system type of the edge device used for current test of the deep learning model; and
compiling and packaging, by the compiler, algorithmic code corresponding to the deep learning model into a library.

13. The apparatus of claim 12, wherein a type of the packaged library is determined by:
determining, in response to that the compiler is one of GCC compiler, G++ compiler and a cross compiler, the type of the packed library as a Shared Object (SO) library; and
determining, in response to that the compiler is a Windows compiler, the type of the packed library as a Dynamic-Link Library (DLL).

14. The apparatus of claim 12, wherein determining the compiler comprises one of:
determining that the compiler is one of a GCC compiler, a G++ compiler or a cross compiler in response to that a Linux system is used for current test;
determining that the compiler is one of a GCC compiler, a G++ compiler or a cross compiler in response to that an ARM-Linux system is used for current test;
determining that the compiler is one of a GCC compiler, a G++ compiler or a cross compiler in response to that an Android system is used for current test; and
determining that the compiler is a Windows compiler in response to that a Windows system is used for current test.

15. The apparatus of claim 12, wherein after compiling and packaging, by the compiler, algorithmic code corresponding to the deep learning model into a library, the processor is configured to perform a step of:
encapsulating at least one preset function library into the library, wherein the preset function library is configured to realize one or more of an authentication function, an encryption function and a network function.

16. The computer storage medium of claim 10, before accelerating the deep learning model, causes the processor to perform a step of:
selecting, in response to a plurality of acceleration methods corresponding to the acceleration instruction, one of the plurality of acceleration methods meeting a preset performance index according to a system type and hardware performance of the edge device used for current test of the deep learning model.

17. The computer storage medium of claim 10, before testing the deep learning model by using the test samples, causes the processor to perform a step of:
determining a compiler according to a system type of the edge device used for current test of the deep learning model; and
compiling and packaging, by the compiler, algorithmic code corresponding to the deep learning model into a library.

18. The computer storage medium of claim 17, wherein a type of the packaged library is determined by:
determining, in response to that the compiler is one of GCC compiler, G++ compiler and a cross compiler, the type of the packed library as a Shared Object (SO) library; and
determining, in response to that the compiler is a Windows compiler, the type of the packed library as a Dynamic-Link Library (DLL).

19. The computer storage medium of claim 17, wherein determining the compiler comprises one of:
determining that the compiler is one of a GCC compiler, a G++ compiler or a cross compiler in response to that a Linux system is used for current test;
determining that the compiler is one of a GCC compiler, a G++ compiler or a cross compiler in response to that an ARM-Linux system is used for current test;
determining that the compiler is one of a GCC compiler, a G++ compiler or a cross compiler in response to that an Android system is used for current test; and
determining that the compiler is a Windows compiler in response to that a Windows system is used for current test.

20. The computer storage medium of claim 17, wherein after compiling and packaging, by the compiler, algorithmic code corresponding to the deep learning model into a library, causes the processor to perform a step of:
encapsulating at least one preset function library into the library, wherein the preset function library is configured to realize one or more of an authentication function, an encryption function and a network function.
